(19) United States
(12) Patent Application Publication
(10) Pub. No.: US 2013/0188579 A1
(43) Pub. Date: Jul. 25, 2013

(54) MIMO/XPIC RECEIVER

(71) Applicant: QUALCOMM INCORPORATED, San Diego, CA (US)

(72) Inventors: Assaf Touboul, Ra'anana (IL); Maxim Gotman, Ra'anana (IL); Oren Matsrafi, Ra'anana (IL)

(73) Assignee: QUALCOMM INCORPORATED, San Diego, CA (US)

(21) Appl. No.: 13/747,123

(22) Filed: Jan. 22, 2013

Related U.S. Application Data
(60) Provisional application No. 61/589,406, filed on Jan. 23, 2012.

(51) Int. Cl. H04B 7/04

(52) U.S. Cl. CPC H04B 7/0413
USPC 370/329

(57) ABSTRACT

Methods, systems, and apparatuses are described for receiving a plurality of spatially multiplexed multiple-input multiple-output (MIMO) single carrier signals in a wireless modem. The signals may be received over multiple antennas associated with the modem, and a multiplication stage of frequency domain equalization may be performed on each of the signals in multiple branches of the modem. Each of the branches may be transformed to a time domain after performing the multiplication stage. An identified differential phase error between the different antennas may then be suppressed in the time domain by rotating a phase of at least one of the signals in each of a number of pairs of the branches. A summation stage of equalization may be performed on a sample-by-sample basis in the time domain on each of the signals after suppressing the identified differential phase error.

### CROSS REFERENCES

The present application for patent claims priority benefit to U.S. Provisional Patent Application No. 61/589,406, entitled “MIMO/XPIC Receiver and Method” by Touboul et al., filed Jan. 23, 2012, assigned to the assignee hereof, and expressly incorporated by reference herein.

### BACKGROUND

In modern communications systems, the Multiple-In-Multiple-Out Spatial Multiplexing (MIMO SM) technique has been widely adopted for achieving increased link capacity. In MIMO SM, a transmitter transmits K≧2 independent data streams over the same time-frequency resources, separating the streams in space and/or by polarization (when K=T=2), exploiting T≧K transmit antennas to reach R≧T antennas in the receiver. This approach may allow up to a K-fold increase in the link capacity with respect to the single stream approach, at the expense of increased hardware cost and of a more complex receiver. Examples of systems exploiting MIMO SM techniques include, but are not limited to, WiMAX® Matrix B scheme, LTE® SM-MIMO transmit mode, cross-polarization interference cancellation (XPIC) transceivers used in microwave point-to-(multi)point communications where spatial multiplexing is enhanced using cross-polarization discrimination (XPD) between the antennas, etc.

Traditionally, communications systems designed for non-line of sight (NLOS) operation over frequency selective fading channels, with relatively long delay spreads, exploit orthogonal frequency division multiplex (OFDM) modulation. While demonstrating good properties combating fading channels, OFDM can have several drawbacks, including low spectral efficiency, high peak-to-average-power ratio (PAPR), expensive components, and susceptibility to phase noise. For these reasons, single carrier modulation schemes are typically chosen for high capacity point-to-point line of sight (LOS) microwave communications with high levels of phase noise. Whereas OFDM receivers are typically frequency domain based, single carrier MIMO SM receivers are traditionally time domain based. Consequently, different baseband modems are typically used for OFDM MIMO receivers and single carrier MIMO receivers.

Because of these differences between OFDM and single-carrier based MIMO schemes, traditional wireless devices implementing both NLOS and LOS communications typically employ separate baseband modems with different hardware platform designs for different frequency bands. The use of separate hardware platforms for the different bands may be costly and reduce manufacturing, distribution, management, and support efficiencies.

### SUMMARY

The present disclosure generally relates to one or more improved systems, methods, and/or apparatuses for receiving a plurality of spatially multiplexed MIMO single carrier signals in a wireless modem.

In accordance with a first set of embodiments, the plurality of spatially multiplexed MIMO single carrier signals may be received over a plurality of different antennas associated with the wireless modem, and a multiplication stage of frequency domain equalization may be performed on each of the signals in multiple branches of the wireless modem. Each of the branches may be separately transformed to a time domain after performing the multiplication stage. An identified phase error between the different antennas may be suppressed in the time domain by rotating a phase of at least one of the signals in each of a number of pairs of the branches, after performing the multiplication stage of frequency domain equalization and transforming each of the branches to the time domain. A summation stage of equalization may be performed on a sample-by-sample basis in the time domain on each of the signals, after suppressing the identified phase error.

In certain examples, the modem may be capable of receiving over both a line of sight (LOS) band and a non-line of sight (NLOS) band, and a single carrier wireless channel may be selected from either the LOS band or the NLOS band for receiving the signals. A cyclic prefix may be removed from each of the signals. The cyclic prefix may have a tunable length based at least in part on an estimated delay spread associated with the selected single carrier wireless channel. In certain examples, the tunable length of the cyclic prefix may be further based at least in part on an estimated phase noise level associated with the selected single carrier wireless channel.

A Fast Fourier Transform (FFT) may be performed on each of the signals prior to the frequency domain equalization. In certain examples, a block size associated with the FFT may be based at least in part on the estimated delay spread associated with the selected single carrier wireless channel. The frequency domain equalization may, therefore, be performed on a block-by-block basis, and the phase noise suppression may be performed on a sample-by-sample basis. In certain examples, an inverse FFT (IFFT) may be performed on each of the branches following the frequency domain equalization. The IFFT may be performed by a separate IFFT circuit for each for each of the branches.

In certain examples, the signals may be summed in the time domain following the frequency domain equalization and the suppression of the identified differential phase error between the signals.

In certain examples, a general phase error applicable to each of the signals may be identified, and a phase of the sum of the signals may be rotated in the time domain to suppress the identified general phase error.

In certain examples, frequency domain equalization coefficients for frequency domain processing of at least one of the signals may be determined based at least in part on a pilot sequence of a preamble of the at least one of the signals. In certain examples, the frequency domain equalization may be performed using a single-tap frequency domain equalizer.

In accordance with a second set of embodiments, a wireless modem may include a receiver circuit, multiple Fast Fourier Transform (FFT) circuits, a frequency domain equalization circuit, and a time domain phase noise suppression circuit. The receiver circuit may be configured to receive a spatially multiplexed multiple-input multiple output (MIMO) single carrier signals over different antennas associated with the wireless modem. An input of each FFT circuit may be communicatively coupled with an output of a different one of the antennas. The frequency domain equalization circuit may be communicatively coupled with an output of each of the FFT circuits, and configured to perform a multiplication stage of frequency domain equalization on each of the signals in multiple branches of the wireless modem. The time domain phase noise suppression circuit may be communicatively coupled with an output of the frequency domain equalization circuit, and configured to identify and suppress a differential phase error between the different antennas by rotating a phase of at least one of the signals in each of a number of pairs of the branches. The time domain summation circuit may be communicatively coupled with an output of the time domain phase noise suppression circuit, and configured to perform a summation stage of equalization on a sample-by-sample basis on each of the signals.

In certain examples, the wireless modem may include a selection circuit configured to select a single carrier wireless channel from one of a line of sight (LOS) band or a non-line of sight (NLOS) band for receiving the signals. The modem may be capable of receiving over both the LOS band and the NLOS band. The wireless modem may further include a tunable cyclic prefix removal circuit configured to remove from each of the signals a cyclic prefix having a tunable length, where the tunable length is based at least in part on an estimated delay spread associated with the selected single carrier wireless channel. The tunable length of the cyclic prefix may be further based on at least an estimated phase noise level associated with the selected single carrier wireless channel.

In certain examples, the wireless modem may include a Fast Fourier Transform (FFT) circuit configured to perform a FFT on each of the signals prior to the frequency domain equalization. A block size associated with the FFT may be based at least in part on the estimated delay spread associated with the selected single carrier wireless channel. Thus, in certain examples, the frequency domain equalization may be performed on a block-by-block basis, and the phase noise suppression may be performed on a sample-by-sample basis The wireless modem may further include a time domain transformation circuit including an inverse FFT (IFFT) circuit configured to perform an IFFT on each of the branches following the frequency domain equalization.

In certain examples, the wireless modem of may include a summer for summing the signals in the time domain following the frequency domain equalization and the suppression of the identified differential phase error between the signals.

In certain examples, the wireless modem may further include a general phase error identification circuit configured to identify a general phase error applicable to each of the signals and a phase rotator circuit configured to rotate a phase of the sum of the signals in the time domain to suppress the identified general phase error.

In certain examples, the wireless modem may include a coefficient determining circuit configured to determine frequency domain equalization coefficients for frequency domain processing of at least one of the signals based at least in part on a pilot sequence of a preamble of the at least one of the signals. The frequency domain equalization circuit may be configured to perform the frequency domain equalization using a single-tap frequency domain equalizer.

In accordance with a third set of example embodiments, an apparatus for receiving multiple spatially multiplexed multiple-input multiple-output (MIMO) single carrier signals may include: means for receiving the plurality of spatially multiplexed MIMO single carrier signals over a plurality of different antennas associated with the apparatus; means for performing a multiplication stage of frequency domain equalization on each of the signals in multiple branches of the apparatus; means, coupled to an output of the means for performing the multiplication stage of frequency domain equalization, for separately transforming each of the branches to a time domain; means, coupled to an output of the means for transforming each of the signals to the time domain, for suppressing an identified differential phase error between the different antennas in the time domain by rotating a phase of at least one of the signals in each of a number of pairs of the branches; and means, coupled to an output of the means for suppressing the identified differential phase error, for performing a summation stage of equalization on a sample-by-sample basis in the time domain on each of the signals.

In certain examples, the apparatus may be capable of receiving over both a line of sight (LOS) band and a non-line of sight (NLOS) band, and the apparatus may include means for selecting a single carrier wireless channel from either the LOS band or the NLOS band for receiving the signals. The apparatus may further include means for removing a cyclic prefix from each of the signals. The cyclic prefix may have a tunable length based at least in part on an estimated delay spread associated with the selected single carrier wireless channel. In certain examples, the tunable length of the cyclic prefix may be further based at least in part on an estimated phase noise level associated with the selected single carrier wireless channel.

In certain examples, the apparatus may include means for performing a Fast Fourier Transform (FFT) on each of the signals prior to the frequency domain equalization. In certain examples, a block size associated with the FFT may be based at least in part on the estimated delay spread associated with the selected single carrier wireless channel. The frequency domain equalization may, therefore, be performed on a block-by-block basis, and the phase noise suppression may be performed on a sample-by-sample basis. In certain examples, an inverse FFT (IFFT) may be performed on each of the branches following the frequency domain equalization.

In certain examples, the apparatus may include means for summing the signals in the time domain following the frequency domain equalization and the suppression of the identified differential phase error between the signals.

In certain examples, the apparatus may further include means for identifying a general phase error applicable to each of the signals, and means for rotating a phase of the sum of the signals in the time domain to suppress the identified general phase error.

In certain examples, apparatus may further include means for determining frequency domain equalization coefficients for frequency domain processing of at least one of the signals based at least in part on a pilot sequence of a preamble of the at least one of the signals. In certain examples, the means for performing the frequency domain equalization may include means for performing the frequency domain equalization using a single-tap frequency domain equalizer.

In accordance with a fourth set of example embodiments, a computer program product may include a compute-readable program device having computer-readable program code stored thereon. The computer readable program code may include: computer-readable program code configured to cause at least one processor to receive a plurality of spatially multiplexed multiple-input multiple-output (MIMO) single carrier signals over a plurality of different antennas associated with a wireless modem; computer-readable program code configured to cause the at least one processor to perform a multiplication stage of frequency domain equalization on each of the signals in multiple branches of the wireless modem; computer-readable program code configured to cause the at least one processor to transform each of the branches to a time domain after the multiplication stage of frequency domain equalization is performed; computer-readable program code configured to cause the at least one processor to suppress an identified differential phase error between the different antennas in the time domain by rotating a phase of at least one of the signals in each of a number of pairs of the branches, after performing the multiplication stage of frequency domain equalization and transforming each of the branches to the time domain; and computer-readable program code configured to cause the at least one processor to perform a summation stage of equalization on a sample-by-sample basis in the time domain on each of the signals, after the suppression of the identified differential phase error.

Further scope of the applicability of the described methods and apparatuses will become apparent from the following detailed description, claims, and drawings. The detailed description and specific examples are given by way of illustration only, as various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of an example of a wireless communications system;

FIG. 2 shows a block diagram of another example of a wireless communications system;

FIG. 3 shows a block diagram of an example of a wireless communications device that may be configured to receive a plurality of spatially multiplexed MIMO single carrier signals in accordance with various embodiments;

FIG. 4 shows a block diagram of an example of a frequency domain processor in accordance with various embodiments;

FIG. 5 shows a block diagram of an example of spatially multiplexed MIMO frequency domain and time domain equalization in accordance with various embodiments;

FIG. 6 shows a block diagram of an example of an XPIC receive pipeline in accordance with various embodiments;

FIG. 7 shows a block diagram of an example of a spatially multiplexed MIMO communications system including first and second base stations;

FIGS. 8A, 8B & 8C show various examples of advanced link topologies that are capable of being supported with a single configurable or programmable cyclic single carrier (CSC) based system;

FIG. 9 is a flow chart illustrating one example of a method for receiving a plurality of spatially multiplexed MIMO single carrier signals in accordance with various embodiments; and

FIG. 10 is a flowchart illustrating one example of a more detailed implementation of the method shown in FIG. 9.

### DETAILED DESCRIPTION

Methods, systems, and apparatuses for receiving a plurality of spatially multiplexed MIMO single carrier signals in a wireless modem are disclosed. The methods, systems, and apparatuses may perform a multiplication stage of frequency domain equalization on each of the signals in multiple branches of the wireless modem, and then transform the branches to a time domain where 1) an identified phase noise between the different antennas that receive the signals is suppressed, and 2) a summation stage of equalization may be performed on a sample-by-sample basis on each of the signals. The methods, systems, and apparatuses propose a modem architecture that balances equalizer length and phase noise suppression level, enabling a single wireless modem or receiver to receive spatially multiplexed MIMO signals ranging from low frequency signals (e.g., NLOS frequency band signals below about 6 GigaHertz (GHz)) to high frequency signals (e.g., LOS frequency band signals above about 6 GHz, such as microwave Point-to-Point (PtP) or E-Band small cell signals). In some cases, the frequency domain equalization may be based on linear MMSE (Minimum Mean-Square Error) estimation.

The disclosed methods, systems, and apparatuses may combine single carrier spectral efficiency and its immunity to phase noise with the power of FD-based equalization tuned for a given frequency band and expected fading channel delay spread. Using the methods, systems, and apparatuses described herein may also allow for optimal deployment-specific tuning of Cyclic Prefix-Single Carrier (CSC) physical (PHY) layer parameters and a mixed Frequency Domain-Time Domain (FD-TD) receiver architecture to achieve better capacity while avoiding unnecessary overhead when a channel has a short delay spread, enabling a long enough equalizer where long delay spread is expected, and providing an optimized phase noise suppression level.

Conventional spatially multiplexed MIMO single carrier/XPIC systems are usually limited to two receive antennas due to the high penalty paid in hardware when cloning time domain equalization chains for each pair of transmit/receive (Tx/Rx) antennas. However, the complexity of single-tap frequency domain equalization performed in accordance with embodiments of the disclosed methods, systems, and apparatuses may be affected to a much lower extent when adding additional receiver antennas. Moreover, having the number of receive antennas, R, greater than the number of receive antennas, T, (i.e., R>T) can improve the performance of linear MMSE equalization compared to the R=T case.

Techniques described herein may be used for various wireless communications systems such as cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

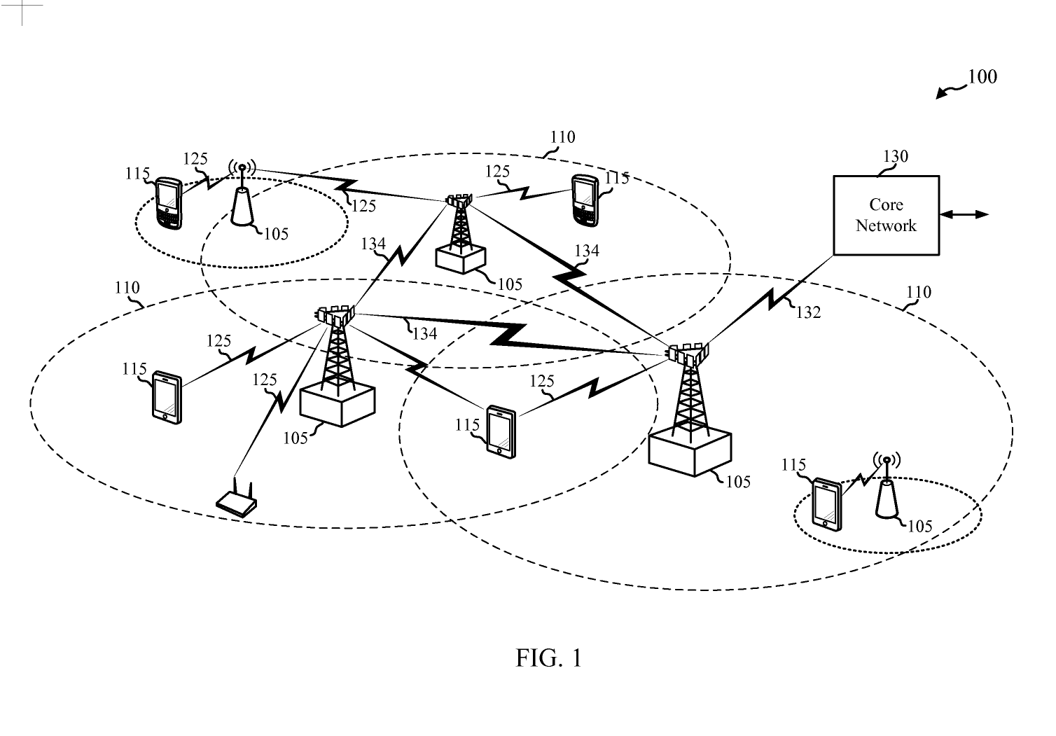

Referring first to FIG. 1, a diagram illustrates an example of a wireless communications system 100. The system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through wired or wireless backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. In some embodiments, each of the base stations 105 may include a multi-mode wireless modem (or multiple multi-mode wireless modems) for communicating with one or more other base stations 105 or the core network 130 via the wireless backhaul links 132 or 134.

The base stations 105 may wirelessly communicate with the devices 115 via one or more base station antennas. Each of the base station 105 sites may provide communication coverage for a respective geographic area 110. In some embodiments, a base station 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In embodiments, the system 100 is an LTE/LTE-A network. In LTE/LTE-A networks, the terms evolved Node B (eNB) and user equipment (UE) may be generally used to describe the base stations 105 and devices 115, respectively. The system 100 may be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 are dispersed throughout the wireless network 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The transmission links 125 shown in network 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions.

The core network 130 may communicate with the eNBs 105 via backhaul links 132 (e.g., S1, etc.). The eNBs 105 may also communicate with one another, e.g., directly or indirectly via backhaul links 134 (e.g., X2, etc.) and/or via backhaul links 132 (e.g., through core network 130). Backhaul links 134 between wireless links and backhaul link 132 to core network 130 may be wireless links implemented using transmitters and receivers at the base stations 105. In certain examples, one or more pairs of the eNBs 105 may be able to establish backhaul links 134 with each other over LOS frequencies. Other pairs of eNBs 105 may not be within a line of sight of each other, and may establish backhaul links 134 over NLOS frequencies. According to the principles of the present description, each of the eNBs 105 may utilize the same multi-mode modem for establishing backhaul links 134, regardless of whether the backhaul links 134 are over an LOS band or an NLOS band.

The multi-mode modems may implement robust backhaul links 134 over a wide range of frequencies based on the use of mixed frequency domain-time domain equalization, where a multiplication stage of frequency domain equalization is performed on multiple branches of the wireless modem, each of the branches is separately transformed to the time domain after the multiplication stage, and a summation stage of the equalization is performed on a sample-by-sample basis in the time domain following the suppression of phase error between pairs of the branches.

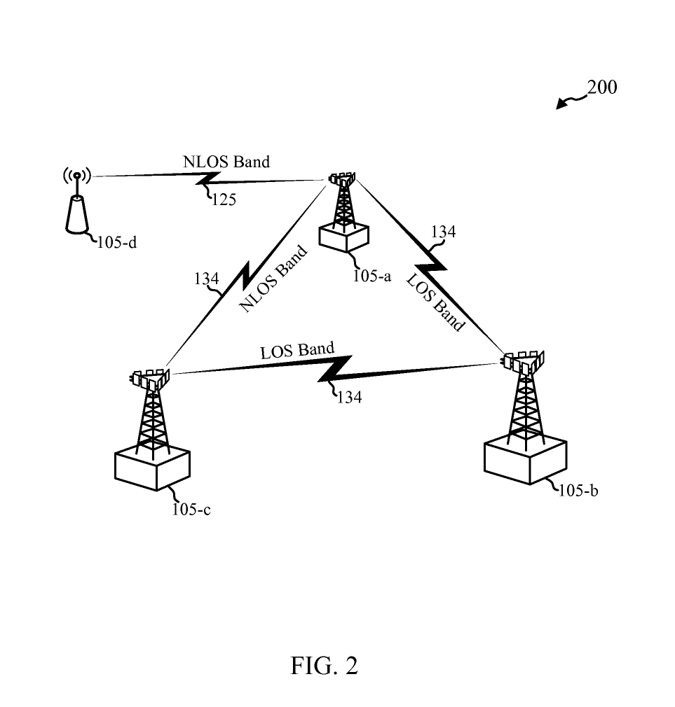

Turning to FIG. 2, there is shown a block diagram of a wireless communications system 200 including four base stations 105-a, 105-b, 105-c, and 105-d. Base stations 105-a and 105-b may communicate wirelessly over a backhaul link 134 operating in an LOS band, as do base stations 105-b and 105-c. Base stations 105-a and 105-c, however, may communicate over a backhaul link 134 operating in an NLOS band, as may base station 105-a and femto cell 105-d (via communication link 125). Despite the different frequency bands in which the base stations 105 communicate, potentially ranging, for example, from less than 6 GHz to over 90 GHz, each of the base stations 105 may utilize the same multi-mode wireless modem, configured or programmed in accordance with the frequency band(s) in use by a particular one of the base stations 105. This may provide streamlined manufacturing, distribution, management and support for base stations operating within a wide range of frequency bands. Use of the same modem hardware is possible for various reasons, such as the use of a multiplication stage of frequency domain equalization, combined with a summation stage of equalization in the time domain, combined with time domain phase noise suppression, as described below.

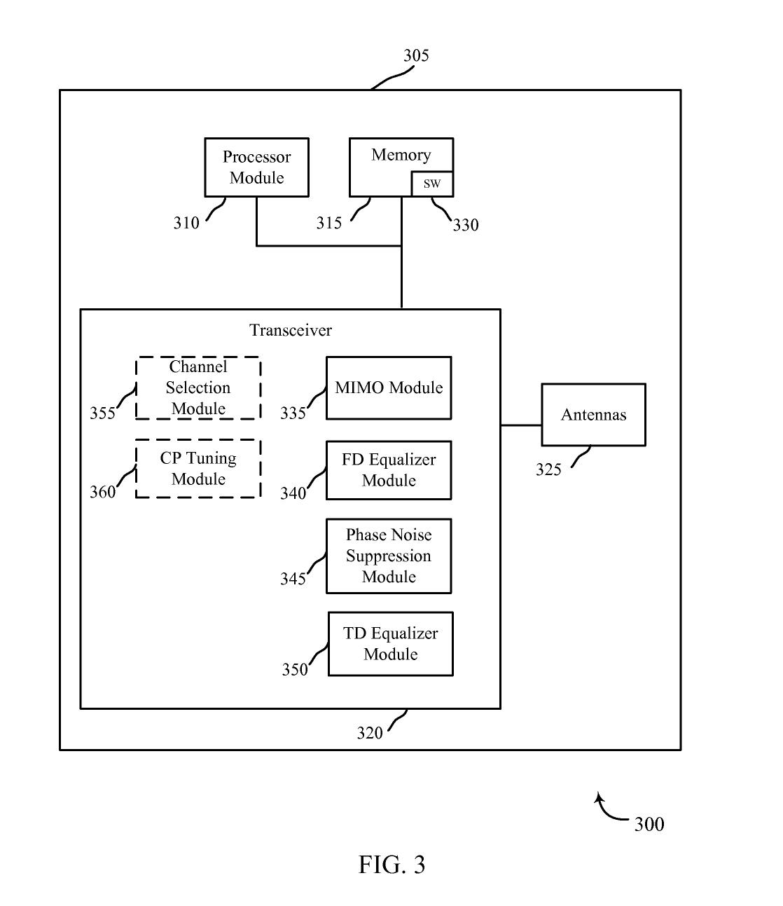

Referring now to FIG. 3, a block diagram 300 illustrates an apparatus or device 305 usable for receiving a plurality of spatially multiplexed MIMO single carrier signals in accordance with various embodiments. The device 305 may in some cases be a multi-mode wireless modem used by one of the base stations 105 described with reference to FIG. 1 or FIG. 2. The device 305 may include a processor module 310, a memory 315, a transceiver module 320, and/or antennas 325. Each of these components may be in communication, directly or indirectly, with each other (e.g., over one or more buses).

The components of the device 305 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. In some cases, some or all of the components of the device 305 may be integrated in a System on Chip (SOC) device. The functions of each unit may also be implemented, in whole or in part, with instructions embodied in a memory, formatted to be executed by one or more general or application-specific processors.

The processor module 310 may include an intelligent hardware device, e.g., a central processing unit (CPU) such as those made by Intel® Corporation or AMD®, a microcontroller, an application-specific integrated circuit (ASIC), etc.

The memory 315 may include random access memory (RAM) or read-only memory (ROM). The memory 315 may also store computer-readable, computer-executable software code 330 containing instructions that are configured to, when executed, cause the processor module 310 to perform various functions described herein. Alternatively, the software code 330 may not be directly executable by the processor module 310 but be configured to cause the processor module 310, e.g., when compiled and executed, to perform functions described herein.

The transceiver module 320 may be configured to communicate bi-directionally, via the antennas 325, with one or more other devices such as one or more multi-mode wireless modems of other base stations 105. The transceiver module 320 may be configured to modulate packets of data and provide the modulated packets to the antennas 325 for transmission, and to demodulate packets received from the antennas 325. The device 305 may include multiple antennas 325 for multiple carriers.

In some embodiments, the transceiver module 320 in conjunction with antennas 325, along with other possible components of the device 305, may facilitate receipt of a plurality of spatially multiplexed MIMO single carrier signals from one or more other devices (e.g., one or more multi-mode wireless modems of other base stations 105). In these embodiments, the transceiver module 320 may include a MIMO module 335, a FD equalizer module 340, a phase noise suppression module 345, and/or a TD equalizer module 350.

The MIMO module 335, also referred to as a receiver circuit, may be used to receive the plurality of spatially multiplexed MIMO single carrier signals over different ones of the antennas 325. The MIMO module 335 may also perform such tasks as removing a CP having a tunable length from each of the signals. More particularly, a CP may be removed from an FDE-block of each of the signals. An FDE-block may be a group of N modulated time-domain complex signals that are buffered to form a frequency domain equalization (FDE) block, with the last symbols (referred to as the CP of the block) being concatenated cyclically to the FDE-block's header. The tunable length of the CP may be based at least in part on an estimated delay spread associated with a single carrier wireless channel over which the spatially multiplexed MIMO single carrier signals are received. The tunable length of the CP may also be based on an estimated phase noise level associated with the single carrier wireless channel. A channel in the LOS band (i.e., a higher frequency channel) may be associated with a shorter delay spread, and thus the tunable length of the CP may be reduced to minimize overhead and increase system capacity, while still offering good robustness against phase noise and keeping the equalization method in the frequency domain simple. In some cases, the tunable length of the CP may be reduced to a single symbol (e.g., in a millimeter-wave application). This may minimize overhead while ensuring single-carrier characteristics in terms of robustness against phase noise and low PAPR. A channel in the NLOS band (i.e., a lower frequency band) will typically be associated with a longer delay spread, and thus the tunable length of the CP may be increased to match OFDM-like performance and reduce PAPR.

The FD Equalizer (FDE) module 340, also referred to as an FDE circuit, may be configured to perform a multiplication stage of frequency domain equalization on each of the signals in multiple branches of the device 305. The FDE module 340 may also take care of transforming the signals to and from the frequency domain for each of the branches (e.g., by respectively performing a FFT and inverse FFT (IFFT) before and after performing the frequency domain equalization). The operations of the FDE module 340 may be performed on a received FDE-block of each of the signals. Examples of a multiplication stage of frequency domain equalization are described in detail later in this description. In some embodiments, the FD equalizer module 340 may be or use a single-tap FD equalizer.

The phase noise suppression module 345, also referred to as a time domain phase noise suppression circuit, may be configured to suppress an identified phase error between the different antennas 325 in the time domain. This may be done by rotating a phase of at least one of the signals in each of a number of pairs of the branches. The rotation may be done after performing the multiplication stage of frequency domain equalization, and after transforming each of the branches back to the time domain.

The TD Equalizer module 350, also referred to as a time domain summation circuit, may perform a summation stage of equalization, on a sample-by-sample basis, on each of the signals. The summation stage of equalization may be performed after suppressing the identified phase error.

An optional channel selection module 355, also referred to as a selection circuit, may be used to select a single carrier wireless channel over which the device 305 will receive signals. The channel may be selected from among a number of channels over which the device 305 may receive signals, depending on a programmable configuration. For example, the device 305 may be capable of receiving signals over both an LOS band and an NLOS band, and may be configured to receive signals over a single carrier wireless channel selected from one of these bands.

An optional CP tuning module 360 may be configured to tune the tunable length of the CP associated with the selected single carrier wireless channel.

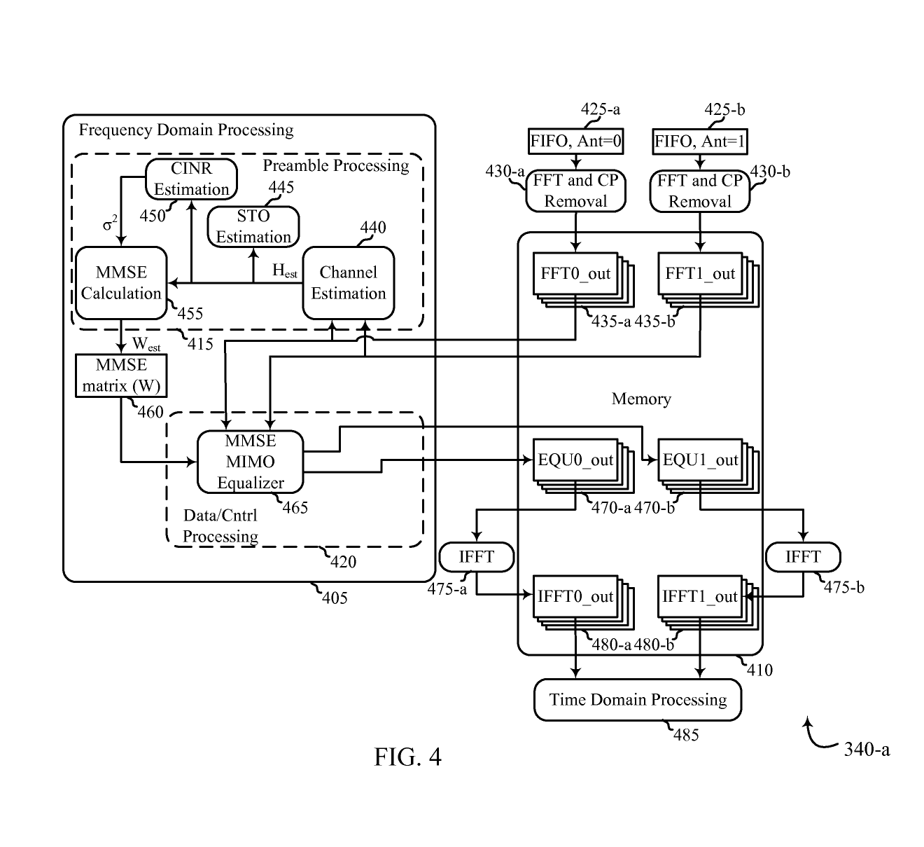

FIG. 4 illustrates a more detailed example of how the FDE module 340 shown in FIG. 3 may be embodied in a spatially multiplexed MIMO single carrier receive pipeline coupled to two antennas (Ant=0, Ant=1). The FDE module 340-a may include a processing module 405 and a memory 410. The processing module 405 may include a preamble processing module 415 and a data and control (data/cntrl) processing module 420.

In the embodiment shown in FIG. 4, frequency domain equalization coefficients may be determined from the preamble (or other known sequence) transmitted ahead of the data blocks in the frame. The preamble can also be utilized to derive many of the critical parameters necessary for practical implementation of communication systems, such as timing offset error due to clock jitter, or carrier frequency offset. Furthermore, such a preamble-based CSC implementation can easily derive channel and system statistics, such as Signal to Noise Ratio, interferences between polarizations in an XPIC system, RSSI (Received Signal Strength Indication), and so on.

An FDE-block is initially received at first-in first-out (FIFO) modules 425-a, 425-b via respective antennas Ant=0 and Ant=1. FFT and CP removal may then be performed for each channel at modules 430-a, 430-b and the frequency domain symbols output therefrom may be stored in FFT0_out and FFT1_out buffers 435-a, 435-b of the memory 410.

At the preamble processing module 415, the channel estimation module 440 may read the preamble symbols of the FDE-block from the FFT0_out and FFT1_out buffers 435-a, 435_{—}b and generate a channel estimation, Hₑₛₜ. The sample time offset (STO) estimation module 445 may estimate the STO of an FDE-block based on its preamble symbols using a least squares algorithm. The CINR estimation module 450 may estimate the CINR and the noise variance, σ², of an FDE-block based on its preamble symbols.

By way of example, the processing module 405 of FIG. 4 is MMSE-based. In other embodiments, other equalization techniques may be used. The MMSE calculation module 455 (or coefficient determining circuit) may perform a minimum mean-square error estimation based on the channel estimation, Hₑₛₜ, and the noise variance estimation, σ². The channel used for MMSE calculation may be averaged between consecutive preambles to reduce the noise floor. The result of the MMSE calculation may be an MMSE matrix (W) 460 specifying frequency domain equalization coefficients. These coefficients may be used by the MMSE MIMO equalizer 465 of the data and control processing module 420 to perform a multiplication stage of frequency domain equalization on the data symbols of an FDE-block retrieved from the FFT0_out and FFT1_out buffers 435-a, 435-b. The frequency domain equalization may be performed using an interpolated channel estimation. The outputs of the MMSE MIMO equalizer 465 may be stored in EQU0_out and EQU1_out buffers 470-a, 470-b.

IFFT modules 475-a, 475-b are used to perform an IFFT on the data stored in the EQU0_out and EQU1_out buffers 470-a, 470-b. The outputs of the IFFT modules 475-a, 475-b may be stored in the IFFT0_out and IFFT 1_out buffers 480-a, 480-b and may be retrievable for subsequent time domain processing 485.

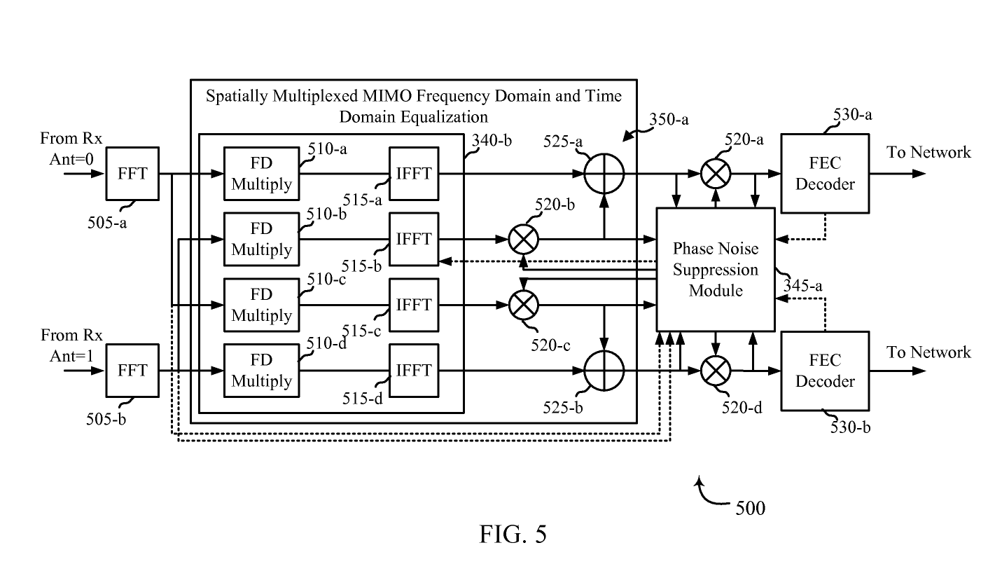

FIG. 5 illustrates a more detailed example 500 of how the FD equalizer module 340, phase noise suppression module 345, and/or TD equalizer module 350 shown in FIG. 3 or FIG. 4 may be embodied in a spatially multiplexed MIMO single carrier receive pipeline (e.g., a MIMO/XPIC pipeline) coupled to two antennas (Ant=0, Ant=1). Although a 2×2 spatially multiplexed MIMO implementation is shown, implementations of any order are possible.

Each of the signals received from the antennas Ant=0 and Ant=1 may be converted to the frequency domain by a respective FFT circuit 505-a, 505-b. Outputs of the FFT circuits 505-a, 505-b may be communicatively coupled with the FD equalizer module 340-b, where a multiplication stage of frequency domain equalization may be performed for each of the signals in multiple branches of the FD equalizer module 340-b. The multiple branches may be defined, in part, by FD multiply modules 510-a, 510-b, 510-c, and 510-d. As shown, each of the signals output by the FFT circuits 505-a, 505-b may be input two different branches (e.g., FD Multiply modules 510-a/510-c, 510-b/510-d) of the FD equalizer module 340-b.

Each branch of the FD equalizer module 340-b may be separately transformed back to the time domain using a separate IFFT circuit 515-a, 515-b, 515-c, 515-d prior to phase error suppression by the phase noise suppression module 345-a. The use of separate IFFT circuits 515 to transform each branch to the time domain following the multiplication stage of frequency domain equalization, but prior to a summation stage of the equalization differs from conventional SC-FDMA receivers, where IFFTs are applied on fully FD-equalized signals.

The phase noise suppression module 345-a may be coupled with an output of the FD equalizer module 340-b and suppress an identified phase error between the different antennas (e.g., Ant=0, Ant=1) in the time domain by rotating a phase of at least one of the signals in each of a number of pairs of the branches (e.g., at least one of the signals output by IFFT circuits 515-a/515-c, and at least one of the signals output by IFFT circuits 515-b/515-d may be rotated by phase rotators or phase rotator circuits 520-b and 520-c. The phase noise suppression module 345-a may also identify a general phase error applicable to each of the signals, and rotate a phase of the sum of the signals in the time domain (described later) to suppress the identified general phase error. The general phase error may be suppressed using the phase rotators or phase rotator circuits 520-a and 520-d. The phase noise suppression module 345-a, in conjunction with the phase rotator circuits 520-a and 520-d, may form a general phase noise error identification circuit. The phase rotations may be performed after the multiplication stage of frequency domain equalization and after transforming each of the branches to the time domain. The phase noise suppression module 345-a may utilize differential phase locked loops (PLLs) or cross-phase locked loops (XPLLs) on the cross-terms samples to estimate and correct the aforementioned phase error. In some embodiments, a set of 1×PLLs per branch of the FD equalizer module 340-b and 1×PLLs to cross branches of the FD equalizer module 340-b may be used to estimate the phase error.

After suppressing the identified phase error, a pair of summers 525-a, 525-b forming the TD equalizer module 350-a may perform a summation stage of equalization on a sample-by-sample basis on each of the signals. Each summer 525-a, 525-b may be communicatively coupled with an output of the phase noise suppression module 345-a.

In certain examples, the phase noise suppression module 345-a may also identify a general carrier frequency offset (CFO) applicable to each of the receive antennas, and use phase rotators to correct the CFO(s) in the beginning of the receive pipelines, to minimize the residual CFO carried by the signal as the signal enters other blocks (e.g., FTC, matched filter, equalization, PLL) of the receive pipelines, thereby improving the performance of the other blocks.

The receive pipeline shown in FIG. 5 may include additional hardware blocks compared to more traditional receive pipeline architectures. Namely, the receive pipeline shown in FIG. 5 may include FFT and IFFT circuits of configurable transform length for easier TD-FD and FD-TD transformations of signals. Furthermore, the signals received from the multiple antennas may be split into FDE-blocks (‘long symbols’) of flexible size N_{FFT} according to specific propagation reality (e.g., sufficiently long compared to the expected maximum delay spread of a selected single carrier wireless channel). In the FD part of the equalization, the FD samples may be multiplied with the FD version of the spatially multiplexed MIMO equalizer matrix instead of the traditional TD convolution using Finite Impulse Response (FIR) filters-equalizers. Then, each FD equalized branch may undergo IFFT conversion back to TD, with ‘crossed’ branches being rotated to compensate for phase error due to any phase difference developed between uncorrelated phase-noise sources of different receive antennas. After the phase error is corrected, the TD stage of the equalization may be performed by summing the main and ‘cross’ equalized branches for interference cancellation. Finally, each equalized stream may undergo its main phase noise suppression and continue to a Forward Error Correction (FEC) decoder 530-a, 530-b for FEC decoding.

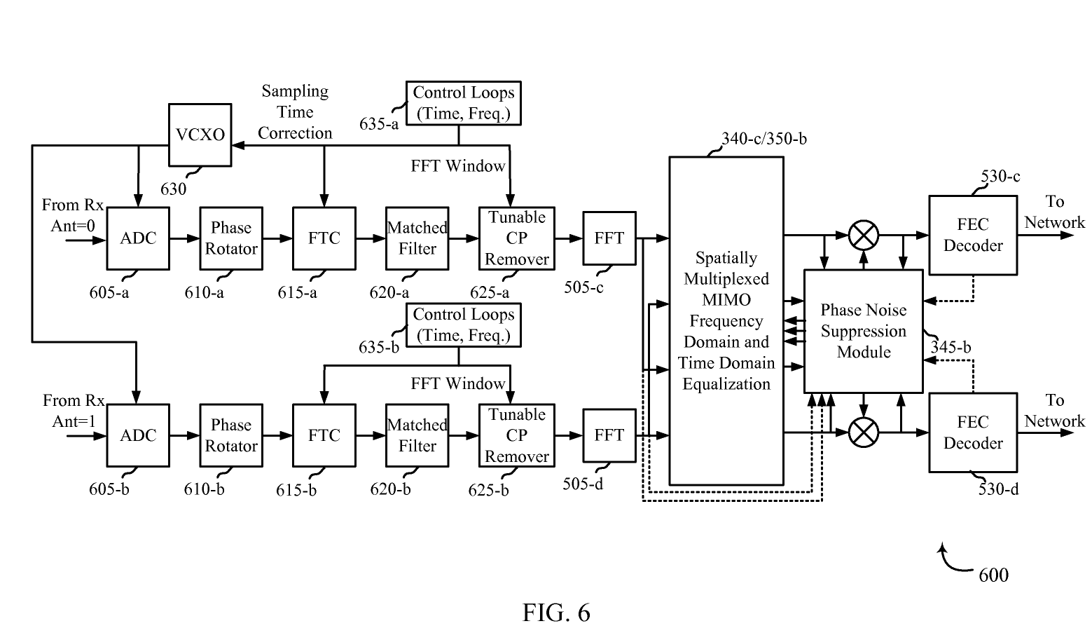

FIG. 6 is a block diagram 600 of an XPIC receive pipeline in the PHY layer. The receive pipeline may in some cases be incorporated into one of the base stations 105 described with reference to FIG. 1 or FIG. 2, or into the device 305 described with reference to FIG. 3. The receive pipeline may include, for each antenna, an analog-to-digital converter (ADC) 605-a, 605-b, a phase rotator 610-a, 610-b, a fine timing correction (FTC) 615-a, 615-b, a matched filter 620-a, 620-b, a tunable CP remover 625-a, 625-b, an FFT circuit 505-c, 505-d, and an FEC Decoder 530-c, 530-d. The receive pipeline may also include a shared VXCO 630, shared FD and TD equalizer modules 340-c, 350-b, and a shared phase noise suppression module 345-b.

Incoming signals on a selected single carrier wireless channel may be sampled by the ADCs 505-a, 505-b and converted to digital form. In some embodiments, the incoming signals may include groups of N modulated time-domain complex signals that are buffered to form a frequency domain equalization (FDE) block, with a set number of last symbols in the block (referred to as the CP of the block) being concatenated cyclically to the header of the block. The digital signals may then be processed through various blocks before having a CP removed from each FDE-block of the signal at the tunable CP removers 625-a, 625-b, also referred to as tunable CP removal circuits. Assuming the channel delay spread is smaller than the tunable length of the CP, removal of the CP may yield inter-block interference-free blocks of symbols.

After CP removal, an FDE-block of symbols may be processed by the shared FD and TD equalizer modules 340-c, 350-b, as well as the phase noise suppression module 345-b. The FD equalizer module 340-c may process samples on a block-by-block basis, while the phase noise suppression module 345-b and TD equalizer module 350-b may process samples on a sample-by-sample basis. Example embodiments of the FD and TD equalizer modules 340-c, 350-b, as well as the phase noise suppression module 345-b, are described with reference to FIG. 5.

The FD equalizer module 340-c may perform channel estimation and equalization. In some embodiments, this may be done as described with reference to FIG. 4. Channel estimation may be performed using the preamble FDE-block, with the result of the channel estimation being used for the rest of the FDE-blocks in the frame. The FD equalizer 340-c may also determine a Sample Time Offset (STO) and Carrier to Interference-plus-Noise Ratio (CINR). Both of these estimations may be derived from the preamble of the FDE-block.

The time domain based control loops 635-a, 635-b may be used to acquire a source sampling clock frequency, filtering the clock source phase noise to provide a clean and accurate sampling clock to respective ones of the ADCs 605-a, 605-b. The control loops 635-a, 635-b may be responsive to the STO for a single preamble and may be operative to adjust sample times associated with the incoming signals in the time domain, based at least in part on the STO. This may be done by generating and outputting a sampling time correction to the shared VCXO 630. The VCXO 630, in turn, may generate the clocks for the ADCs 605-a, 605-b and receive pipeline (including the FTCs 615-a, 615-b and tunable CP removers 625-a, 625-b). In this manner, a closed timing loop may be implemented. The control loops 635-a, 635-b may also select the FFT window sizes associated with frequency domain processing of the incoming signals, again based at least in part on the STO.

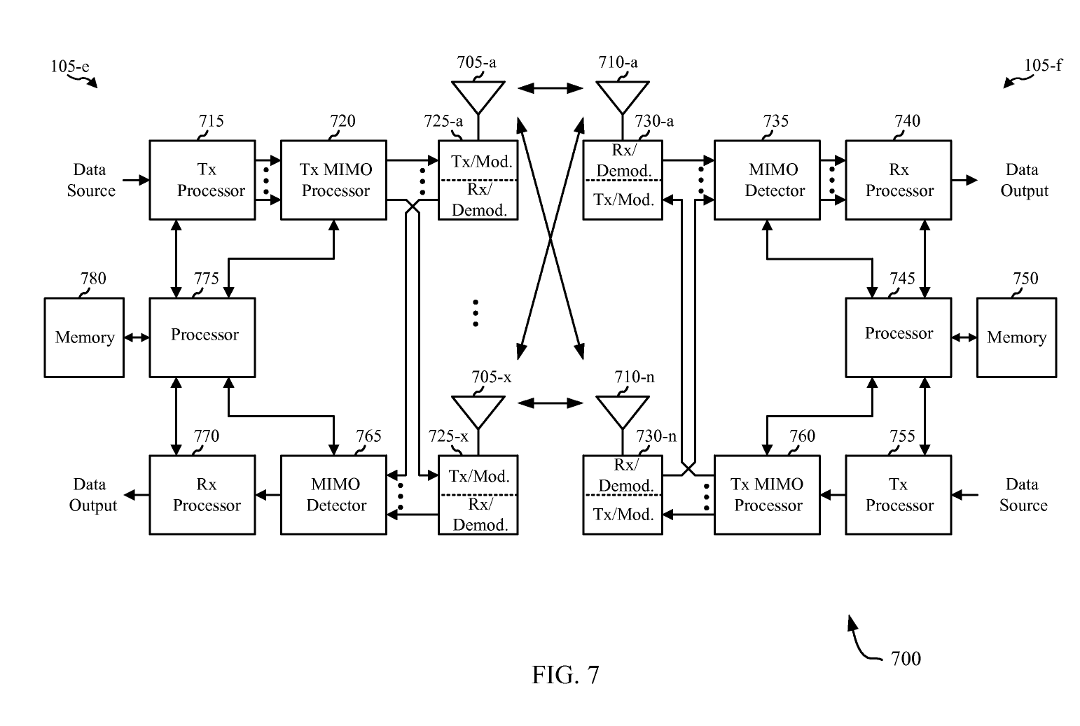

FIG. 7 is a block diagram of a MIMO communications system 700 including a base station 105-e and a base station 105-f. The system 700 may illustrate aspects of the system 100 of FIG. 1 and/or system 200 of FIG. 2. The base station 105-e may be equipped with antennas 705-a through 705-x, and the base station 105-f may be equipped with antennas 710-a through 710-n. In the system 700, each of the base stations 105-e, 105-f may be able to send data over multiple communication links at the same time. Each communication link may be called a “layer” and the “rank” of the communication link may indicate the number of layers used for communication. For example, in a 2×2 MIMO system where base station 105-e transmits two “layers,” the rank of the communication link between the base station 105-e and the base station 105-f is two.

At the base station 105-e, a transmit processor 715 may receive data from a data source. The transmit processor 715 may process the data. The transmit processor 715 may also generate reference symbols, and a cell-specific reference signal. A transmit (TX) MIMO processor 720 may perform spatial processing (e.g., precoding) on data symbols, control symbols, and/or reference symbols, if applicable, and may provide output symbol streams to the transmit modulators 725-a through 725-x. Each modulator 725 may process a respective output symbol stream (e.g., for CSC, etc.) to obtain an output sample stream. Each modulator 725 may further process (e.g., convert to analog, amplify, filter, and upconvert) the output sample stream. In one example, signals from modulators 725-a through 725-x may be transmitted via the antennas 705-a through 705-x, respectively.

At the base station 105-f, the antennas 710-a through 710-n may receive the signals transmitted from the base station 105-d and may provide the received signals to the demodulators 730-a through 730-n, respectively. Each demodulator 730 may condition (e.g., filter, amplify, downconvert, and digitize) a respective received signal to obtain input samples. Each demodulator 730 may further process the input samples (e.g., for OFDM, etc.) to obtain received symbols. A MIMO detector 735 may obtain received symbols from all the demodulators 730-a through 730-n, perform MIMO detection on the received symbols if applicable, and provide detected symbols. A receive processor 740 may process (e.g., demodulate, deinterleave, and decode) the detected symbols, providing decoded data for the base station 105-f to a data output, and provide decoded control information to a processor 745, or memory 750.

At the base station 105-f, a transmit processor 755 may receive and process data from a data source. The transmit processor 755 may also generate reference symbols for a reference signal. The symbols from the transmit processor 755 may be precoded by a transmit MIMO processor 760 if applicable, further processed by the demodulators 730-a through 730-n (e.g., for SC-FDMA, etc.), and be transmitted to the base station 105-e in accordance with the transmission parameters received from the base station 105-e. At the base station 105-e, the signals transmitted from the base station 105-f may be received by the antennas 705, processed by the demodulators 725, detected by a MIMO detector 765 if applicable, and further processed by a receive processor 770. The receive processor 770 may provide decoded data to a data output and to the processor 775 or memory 780.

In some embodiments, some or all of the receive pipeline components described with reference to FIGS. 3, 4, 5, and/or 6 may be implemented within one or more of the receive (Rx) demodulators 725 or 730 of the base station 105-e or the base station 105-f.

The components of the base station 105-e may, individually or collectively, be implemented with one or more Application Specific Integrated Circuits (ASICs) adapted to perform some or all of the applicable functions in hardware. Each of the noted modules may be a means for performing one or more functions related to operation of the system 700. Similarly, the components of the base station 105-f may, individually or collectively, be implemented with one or more Application Specific Integrated Circuits (ASICs) adapted to perform some or all of the applicable functions in hardware. Each of the noted components may be a means for performing one or more functions related to operation of the system 700.

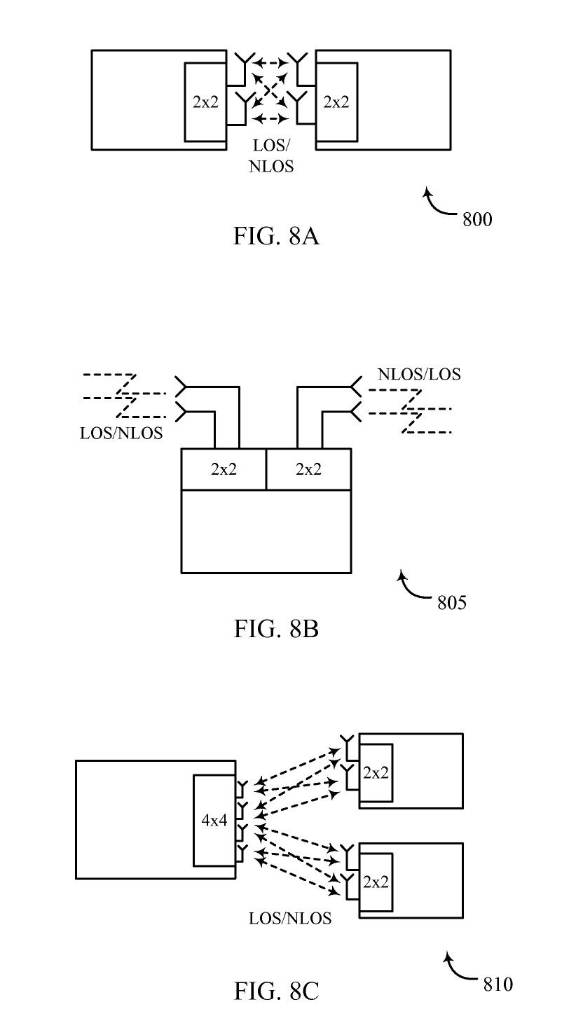

FIGS. 8A, 8B and 8C depict various implementations of advanced link topologies 800, 805, 810 that are capable of being supported with a single configurable or programmable CSC based system (e.g., device 305 shown in FIG. 3, one of base stations 105 shown in FIG. 1, 2, or 7, or any of the receive pipelines shown in FIGS. 4-6). By way of example, the first topology 800 is a point-to-point link, the second topology 805 is a dual-mode relay, and the third topology 810 is a point-to-multipoint link. Each of the topologies 800, 805, 810 may be implemented across a different frequency band, but using the same underlying CSC based system. In such embodiments, for example, the system may implement a dual-mode relay 805 capable of distributing a high capacity E-band (60-90 GHz) link to an NLOS-backhauled base station, yet also implement a microwave relay for extended range, merely by tuning the CP length according to a desired operating frequency band.

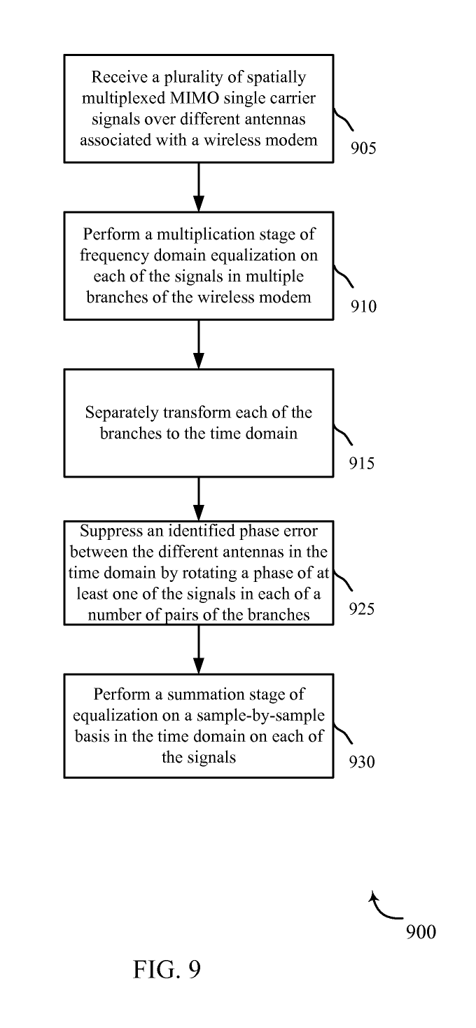

FIG. 9 is a flow chart illustrating one example of a method 900 enabling receipt of a plurality of spatially multiplexed MIMO single carrier signals in a wireless. For clarity, the method 900 is described below with reference to the device 305 shown in FIG. 3, or one of the receive pipelines shown in FIGS. 4-6, or one of the base stations 105 shown in FIG. 1, 2, or 7. In one implementation, the MIMO module 335, FD equalizer module 340, phase noise suppression module 345, and TD equalizer module 350 shown in FIG. 3 may execute one or more sets of codes to control the functional elements of the device 305 to perform the functions described below.

At block 905, a plurality of spatially multiplexed MIMO single carrier signals may be received over different antennas associated with a wireless modem. At block 910, a multiplication stage of frequency domain equalization may be performed on each of the signals in multiple branches of the wireless modem. At block 915, each of the branches may be separately transformed to a time domain after performing the multiplication stage. At block 920, an identified phase error between the different antennas may be suppressed in the time domain by rotating a phase of at least one of the signals in each of a number of pairs of the branches, after performing the multiplication stage of frequency domain equalization and transforming each of the branches to the time domain. At block 925, a summation stage of equalization may be performed on a sample-by-sample basis in the time domain on each of the signals. This may occur suppressing the identified phase error.

Thus, the method 900 may enable receiving a plurality of spatially multiplexed MIMO single carrier signals in a wireless modem over most any frequency band, from the NLOS band to the LOS band, from the NLOS band to the LOS band. It should be noted that the method 900 is just one implementation and that the operations of the method 900 may be rearranged or otherwise modified such that other implementations are possible.

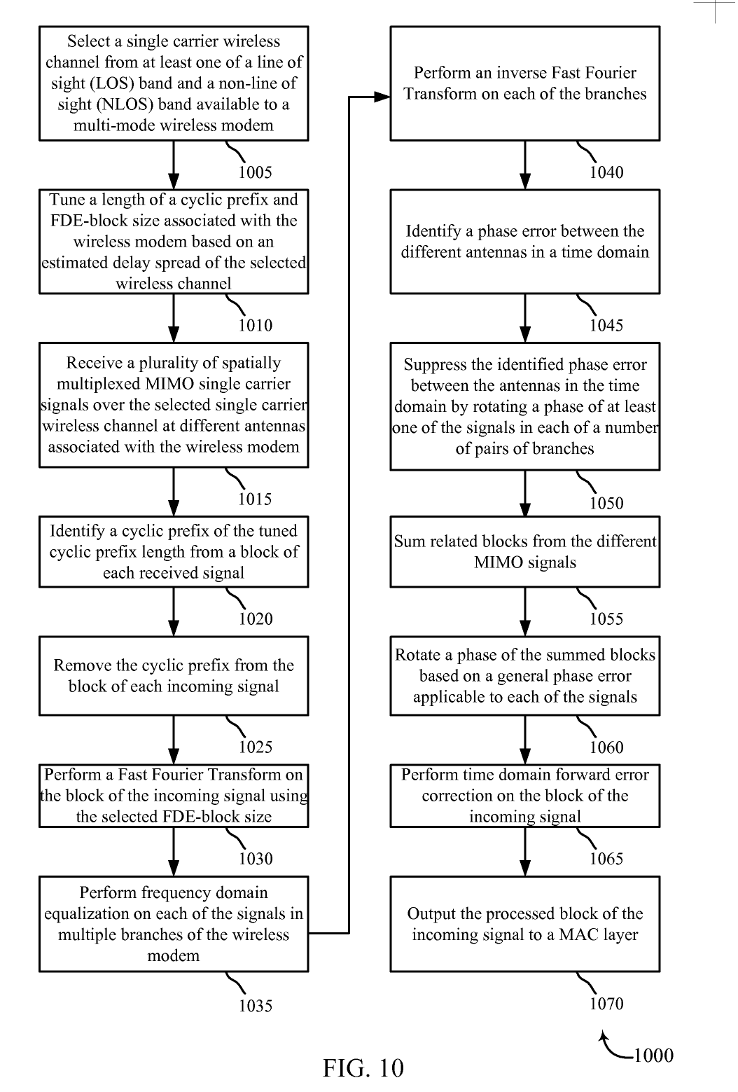

FIG. 10 is a flow chart illustrating one example 1000 of a more detailed implementation of the method 900 shown in FIG. 9. For clarity, the method 1000 is described below with reference to the device 305 shown in FIG. 3, or one of the receive pipelines shown in FIGS. 4-7, or one of the base stations 105 shown in FIGS. 1, 2, and/or 8.

At block 1005, a single carrier wireless channel may be selected from at least one of a LOS band and a NLOS band available to a multi-mode wireless modem. The channel may be selected, in some embodiments, using the channel selection module 355 shown in FIG. 3.

At block 1010, a length of a CP and FDE-block size associated with the wireless modem (i.e., a block size associated with a FFT and subsequent frequency domain processing to be performed) may be tuned based on an estimated delay spread of the selected wireless channel. This tuning may be performed, in some embodiments, using the CP tuning module 360 shown in FIG. 3 and/or the tunable CP removers 625-a, 625-b shown in FIG. 6.

At block 1015, a plurality of spatially multiplexed MIMO single carrier signals may be received over the selected single carrier wireless channel at different antennas associated with the wireless modem. The signals may be received, in some examples, by the antennas 325 shown in FIG. 3, by the FIFO blocks 425-a, 425-b shown in FIG. 4, or by the ADCs 605-a, 605-b shown in FIG. 6, or by the receive demodulators 725-a through 725-x or 730-a through 730-n shown in FIG. 7.

At block 1020, a CP of the tuned CP length may be identified from a block of each received signal, and at block 1025, the CP may be removed from the block of each received signal. These actions may be accomplished, for example, by the MIMO module 335 shown in FIG. 3, the FFT and CP removal blocks 430-a, 430-b shown in FIG. 4, or the tunable CP removers 625-a, 625-b shown in FIG. 6.

At block 1030, a FFT may be performed on the block of the incoming signal using the selected FDE-block size. The FFT may be performed, for example, using the FD equalizer module 340 shown in FIG. 3, the FFT and CP removal blocks 430-a, 430-b shown in FIG. 4, or the FFT circuits 505 shown in FIG. 5 or FIG. 6.

At block 1035, frequency domain equalization may be performed on each of the signals, in multiple branches of the wireless modem. The frequency domain equalization may be performed, in some embodiments, by the FD equalizer module 340 shown in any of FIGS. 3-6.

At block 1040, an IFFT may be performed on each of the branches of the wireless modem. The IFFT may be performed, for example, using the FD equalizer module 340 shown in FIG. 3, the IFFT blocks 475-a, 475-b shown in FIG. 4, or the IFFT circuits 515 shown in FIG. 5.

At block 1045, a phase error between the different antennas of the wireless modem may be identified in a time domain. In some embodiments, the phase error may be detected using the phase noise suppression module 345 shown in any of FIG. 3, 5, or 6.

At block 1050, the identified phase error between the antennas may be suppressed in the time domain by rotating a phase of at least one of the signals in each of a number of pairs of branches. The phase error suppression may be performed, in some cases, using the phase noise suppression module 345 shown in any of FIG. 3, 5, or 6, and/or the phase rotators 520-c or 520-d shown in FIG. 5 or FIG. 6.

At block 1055, related blocks from the different spatially multiplexed MIMO single carrier signals may be summed in the time domain. In some examples, the summation may occur at the TD equalizer module 350 shown in any of FIG. 3, 5, or 6, and/or the summers 525-a, 525-b shown in FIG. 5.

At block 1060, a phase of the summed blocks may be rotated based on a general phase error applicable to each of the signals. This may be accomplished using the phase noise suppression module 345 shown in FIG. 3, 5, or 6, and/or the phase rotators 520-a, 520-b shown in FIG. 5 or FIG. 6.

At block 1065, time domain forward error correction may be performed on the block of the incoming signal using, for example, the FEC decoders 530 shown in FIG. 5 or FIG. 6.

At block 1070, the processed block of the incoming layer may be output to a medium access control (MAC) layer.

Thus, the method 1000 may enable receiving a plurality of spatially multiplexed MIMO single carrier signals in a wireless modem over most any frequency band, from the NLOS band to the LOS band. It should be noted that the method 1000 is just one implementation and that the operations of the method 1000 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with at least one processor, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one” of indicates a disjunctive list such that, for example, a list of “at least one of A, B, or C” means A or B or C or AB or AC or BC or ABC (i.e., A and B and C).

A computer program product or computer-readable media includes both computer-readable storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for receiving a plurality of spatially multiplexed multiple-input multiple-output (MIMO) single carrier signals in a wireless modem, the method comprising:
receiving the plurality of spatially multiplexed MIMO single carrier signals over a plurality of different antennas associated with the wireless modem;
performing a multiplication stage of frequency domain equalization on each of the signals in multiple branches of the wireless modem;
separately transforming each of the branches to a time domain after performing the multiplication stage;
suppressing an identified differential phase error between the different antennas in the time domain by rotating a phase of at least one of the signals in each of a number of pairs of the branches, after performing the multiplication stage of frequency domain equalization and transforming each of the branches to the time domain; and
performing a summation stage of equalization on a sample-by-sample basis in the time domain on each of the signals, after suppressing the identified differential phase error.

2. The method of claim 1, further comprising:
selecting a single carrier wireless channel from one of a line of sight (LOS) band or a non-line of sight (NLOS) band for receiving the signals, wherein the modem is capable of receiving over both the LOS band and the NLOS band.

3. The method of claim 2, further comprising:
removing from each of the signals a cyclic prefix having a tunable length, the tunable length based at least in part on an estimated delay spread associated with the selected single carrier wireless channel.

4. The method of claim 3, wherein the tunable length of the cyclic prefix is further based at least in part on an estimated phase noise level associated with the selected single carrier wireless channel.

5. The method of claim 3, further comprising:
performing a Fast Fourier Transform (FFT) on each of the signals prior to the frequency domain equalization.

6. The method of claim 5, wherein a block size associated with the FFT is based at least in part on the estimated delay spread associated with the selected single carrier wireless channel.

7. The method of claim 5, wherein:
the frequency domain equalization is performed on a block-by-block basis; and
the phase noise suppression is performed on a sample-by-sample basis.

8. The method of claim 5, wherein the transformation to the time domain comprises:
performing an inverse FFT (IFFT) on each of the branches following the frequency domain equalization.

9. The method of claim 8, wherein the IFFT is performed by a separate IFFT circuit for each of the branches.

10. The method of claim 1, further comprising:
summing the signals in the time domain following the frequency domain equalization and the suppression of the identified differential phase error between the signals.

11. The method of claim 1, further comprising:
identifying a general phase error applicable to each of the signals; and
rotating a phase of the sum of the signals in the time domain to suppress the identified general phase error.

12. The method of claim 1, further comprising:
determining frequency domain equalization coefficients for frequency domain processing of at least one of the signals based at least in part on a pilot sequence of a preamble of the at least one of the signals.

13. The method of claim 1, further comprising:
performing the frequency domain equalization using a single-tap frequency domain equalizer.

14. A wireless modem, comprising:
a receiver circuit configured to receive a plurality of spatially multiplexed multiple-input multiple output (MIMO) single carrier signals over a plurality of different antennas associated with the wireless modem;
a plurality of Fast Fourier Transform (FFT) circuits, an input of each FFT circuit communicatively coupled with an output of a different one of the antennas;
a frequency domain equalization circuit communicatively coupled with an output of each of the FFT circuits, the frequency domain equalization circuit configured to perform a multiplication stage of frequency domain equalization on each of the signals in multiple branches of the wireless modem;
a time domain phase noise suppression circuit communicatively coupled with an output of the frequency domain equalization circuit, the time domain phase noise suppression circuit configured to identify and suppress a differential phase error between the different antennas by rotating a phase of at least one of the signals in each of a number of pairs of the branches; and
a time domain summation circuit communicatively coupled with an output of the time domain phase noise suppression circuit, the time domain summation circuit configured to perform a summation stage of equalization on a sample-by-sample basis on each of the signals.

15. The wireless modem of claim 14, further comprising:
a selection circuit configured to select a single carrier wireless channel from one of a line of sight (LOS) band or a non-line of sight (NLOS) band for receiving the signals, wherein the modem is capable of receiving over both the LOS band and the NLOS band.

16. The wireless modem of claim 15, further comprising:
a tunable cyclic prefix removal circuit configured to remove from each of the signals a cyclic prefix having a tunable length, the tunable length based at least in part on an estimated delay spread associated with the selected single carrier wireless channel.

17. The wireless modem of claim 16, wherein the tunable length of the cyclic prefix is further based at least in part on an estimated phase noise level associated with the selected single carrier wireless channel.

18. The wireless modem of claim 16, further comprising:
a Fast Fourier Transform (FFT) circuit configured to perform a FFT on each of the signals prior to the frequency domain equalization.

19. The wireless modem of claim 18, wherein a block size associated with the FFT is based at least in part on the estimated delay spread associated with the selected single carrier wireless channel.

20. The wireless modem of claim 18, wherein:
the frequency domain equalization is performed on a block-by-block basis; and
the phase noise suppression is performed on a sample-by-sample basis

21. The wireless modem of claim 18, wherein the time domain transformation circuit comprises:
an inverse FFT (IFFT) circuit configured to perform an IFFT on each of the branches following the frequency domain equalization.

22. The wireless modem of claim 14, further comprising:
a summer for summing the signals in the time domain following the frequency domain equalization and the suppression of the identified differential phase error between the signals.

23. The wireless modem of claim 14, further comprising:
a general phase error identification circuit configured to identify a general phase error applicable to each of the signals; and
a phase rotator circuit configured to rotate a phase of the sum of the signals in the time domain to suppress the identified general phase error.

24. The wireless modem of claim 14, further comprising:
a coefficient determining circuit configured to determine frequency domain equalization coefficients for frequency domain processing of at least one of the signals based at least in part on a pilot sequence of a preamble of the at least one of the signals.

25. The wireless modem of claim 14, wherein:
the frequency domain equalization circuit is configured to perform the frequency domain equalization using a single-tap frequency domain equalizer.

26. An apparatus for receiving a plurality of spatially multiplexed multiple-input multiple-output (MIMO) single carrier signals, the apparatus comprising:
means for receiving the plurality of spatially multiplexed MIMO single carrier signals over a plurality of different antennas associated with the apparatus;
means for performing a multiplication stage of frequency domain equalization on each of the signals in multiple branches of the apparatus;
means, coupled to an output of the means for performing the multiplication stage of frequency domain equalization, for separately transforming each of the branches to a time domain;
means, coupled to an output of the means for transforming each of the signals to the time domain, for suppressing an identified differential phase error between the different antennas in the time domain by rotating a phase of at least one of the signals in each of a number of pairs of the branches; and
means, coupled to an output of the means for suppressing the identified differential phase error, for performing a summation stage of equalization on a sample-by-sample basis in the time domain on each of the signals.

27. The apparatus of claim 26, further comprising:
means for selecting a single carrier wireless channel from one of a line of sight (LOS) band or a non-line of sight (NLOS) band for receiving the signals, wherein the modem is capable of receiving over both the LOS band and the NLOS band.

28. The apparatus of claim 27, further comprising:
means for removing from each of the signals a cyclic prefix having a tunable length, the tunable length based at least in part on an estimated delay spread associated with the selected single carrier wireless channel.

29. The apparatus of claim 28, wherein the tunable length of the cyclic prefix is further based at least in part on an estimated phase noise level associated with the selected single carrier wireless channel.

30. The apparatus of claim 28, further comprising:
means for performing a Fast Fourier Transform (FFT) on each of the signals prior to the frequency domain equalization.

31. The apparatus of claim 30, wherein a block size associated with the FFT is based at least in part on the estimated delay spread associated with the selected single carrier wireless channel.

32. The apparatus of claim 30, wherein:
the frequency domain equalization is performed on a block-by-block basis; and
the phase noise suppression is performed on a sample-by-sample basis.

33. The apparatus of claim 30, further comprising:
means for performing an inverse FFT (IFFT) on each of the branches following the frequency domain equalization.

34. The apparatus of claim 26, further comprising:
means for summing the signals in the time domain following the frequency domain equalization and the suppression of the identified differential phase error between the branches.

35. The apparatus of claim 26, further comprising:
means for identifying a general phase error applicable to each of the signals; and
means for rotating a phase of the sum of the signals in the time domain to suppress the identified general phase error.

36. The apparatus of claim 26, further comprising:
means for determining frequency domain equalization coefficients for frequency domain processing of at least one of the signals based at least in part on a pilot sequence of a preamble of the at least one of the signals.

37. The apparatus of claim 26, further comprising:
means for performing the frequency domain equalization using a single-tap frequency domain equalizer.

38. A computer program product, comprising:
a computer-readable program device comprising computer-readable program code stored thereon, the computer-readable program code comprising:
computer-readable program code configured to cause at least one processor to receive a plurality of spatially multiplexed multiple-input multiple-output (MIMO) single carrier signals over a plurality of different antennas associated with a wireless modem;
computer-readable program code configured to cause the at least one processor to perform a multiplication stage of frequency domain equalization on each of the signals in multiple branches of the wireless modem;
computer-readable program code configured to cause the at least one processor to transform each of the branches to a time domain after the multiplication stage of frequency domain equalization is performed;
computer-readable program code configured to cause the at least one processor to suppress an identified differential phase error between the different antennas in the time domain by rotating a phase of at least one of the signals in each of a number of pairs of the branches, after performing the multiplication stage of frequency domain equalization and transforming each of the branches to the time domain; and
computer-readable program code configured to cause the at least one processor to perform a summation stage of equalization on a sample-by-sample basis in the time domain on each of the signals, after the suppression of the identified differential phase error.
